(19) United States
(12) Patent Application Publication
(10) Pub. No.: US 2008/0303668 A1
(43) Pub. Date: Dec. 11, 2008

(54) Retrofittable radio frequency identification connector

(75) Inventors: Bradley A. Rohlf, Lakeville, MN (US); John Michael Fuke, Toronto (CA)

Correspondence Address: IPLM GROUP, P.A., POST OFFICE BOX 18455, MINNEAPOLIS, MN, 55418, US

(73) Assignee: D B Industries, Inc.

(21) Appl. No.: 11/759,366

(22) Filed: Jun. 7, 2007

(51) Int. Cl. G08B 13/14

(52) U.S. Cl. 340/572.1

(57) ABSTRACT

A radio frequency identification connector is configured and arranged to retrofittably connect a radio frequency identification device to a device such as a fall protection and fall arrest safety device.

### RELATED APPLICATIONS

This disclosure is related to the following co-pending applications: (1) “Retrofittable Radio Frequency Identification Tag” by Brent J. Knoll et al., U.S. Provisional Application Ser. No. 60/811,965, filed Jun. 8, 2006; (2) “Radio Frequency Identification Tag” by Brent J. Knoll et al., U.S. patent application Ser. No., 29/249,952, filed Oct. 27, 2006; (3) “Retrofittable Radio Frequency Identification Connectors” by Brent J. Knoll et al., U.S. Provisional Application Ser. No. 60/856,607, filed Nov. 3, 2006; (4) “Radio Frequency Identification Connectors” by Bradley A. Rohlf, U.S. Provisional Application Ser. No. 60/856,771, filed Nov. 3, 2006; (5) “Connector for Radio Frequency Identification Device” by Bradley A. Rohlf, U.S. patent application Ser. No. 29/279,897, filed May 10, 2007; (6) “Retrofittable Radio Frequency Identification Connector” by Brent J. Knoll et al., Attorney Docket No. 221P182USU1, filed Jun. 7, 2007; (7) “Retrofittable Radio Frequency Identification Connector” by Bradley A. Rohlf, Attorney Docket No. 221P201USU1, filed Jun. 7, 2007; (8) “Retrofittable Radio Frequency Identification Connector” by Bradley A. Rohlf, Attorney Docket No. 221P202USU1, filed Jun. 7, 2007; (9) “Radio Frequency Identification Connector” by Bradley A. Rohlf, Attorney Docket No. 221P187USU1, filed Jun. 7, 2007; and (10) “Radio Frequency Identification Connector” by Bradley A. Rohlf, Attorney Docket No. 221P203USU1, filed Jun. 7, 2007; which are not admitted as prior art with respect to the present disclosure by its mention in this section.

### FIELD OF THE INVENTION

The present invention relates to a retrofittable radio frequency identification connector for connecting radio frequency identification devices to devices such as fall protection and fall arrest safety devices.

### BACKGROUND OF THE INVENTION

To comply with industry standards, safety devices used for fall protection and fall arrest purposes should be inspected by the user prior to each use and by a competent person other than the user at least annually. To demonstrate compliance with the industry standards, the results of the inspections should be recorded in an inspection and maintenance log for each safety device identified by the model number, the serial number, and the date manufactured or purchased. The inspection and maintenance log should also include information such as the date inspected, the inspection items noted, corrective action, maintenance performed, and the initials of the person who approved the inspection. Other information may also be included such as the dates of the next inspection and maintenance.

For example, some safety devices commonly include labels on which the inspection and maintenance log information may be recorded. However, these labels may become difficult to write on or read should they become soiled. If a separate inspection and maintenance log is kept, it may be difficult to locate the separate log and keep it current, especially if the log is kept in a different location than the safety devices. Therefore, it is desired to provide an inspection and maintenance log that is easily accessible and convenient to use.

The present invention addresses the problems associated with the prior art devices and provides for radio frequency identification connectors for connecting radio frequency identification devices to devices such as fall protection and fall arrest safety devices for use with inspection and maintenance logs that are easily accessible and convenient to use.

### SUMMARY OF THE INVENTION

One aspect of the present invention provides an identification connector assembly configured and arranged for retrofittable connection to a device comprising an identification device and a housing including a base and a cover. The base includes a cavity configured and arranged to receive the identification device. The cover is configured and arranged to engage the base to secure the identification device within the cavity between the base and the cover.

Another aspect of the present invention provides an identification connector assembly configured and arranged for retrofittable connection to a device comprising an identification device, a base, and a cover. The base includes a cavity configured and arranged to receive the identification device and at least one notch having a ledge. The cover includes a connecting member configured and arranged to engage the ledge to secure the identification device within the cavity between the base and the cover.

Another aspect of the present invention provides an identification connector assembly configured and arranged for retrofittable connection to a device comprising an identification device and a housing. The housing contains the identification device. The housing has a flange extending outward from the housing, and the flange includes an aperture including a rounded portion and a slotted portion. The aperture is configured and arranged to receive a fastener.

### BRIEF DESCRIPTION OF THE DRAWINGS

FIG. 1 is a perspective view of an identification connector assembly constructed according to the principles of the present invention;

FIG. 2 is an exploded perspective view of the identification connector assembly shown in FIG. 1;

FIG. 3 is an exploded side view of the identification connector assembly shown in FIG. 1;

FIG. 4 is a top view of the identification connector assembly shown in FIG. 1 with the cover and the identification device removed;

FIG. 5 is a bottom view of the identification connector assembly shown in FIG. 1; and

FIG. 6 is a bottom view of the identification connector assembly shown in FIG. 1 with an adhesive member operatively connected to the identification connector assembly.

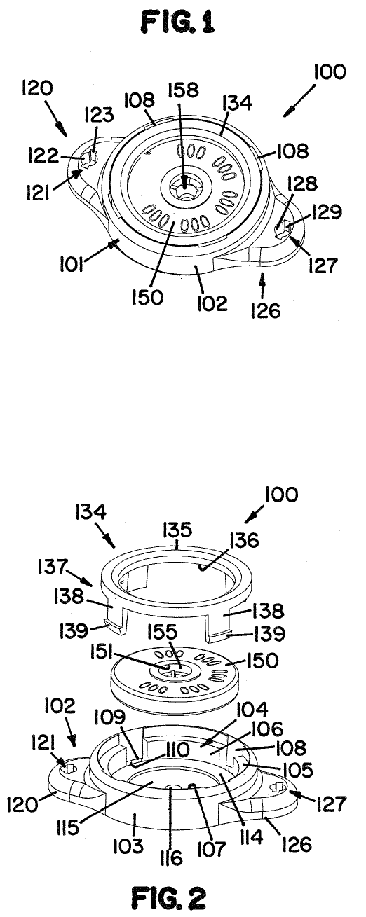

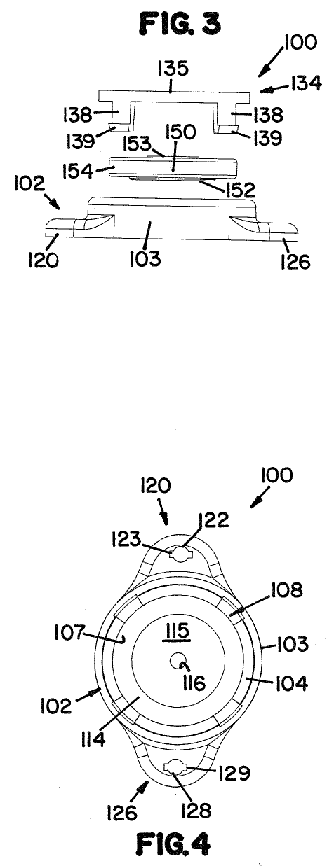

### DETAILED DESCRIPTION OF A PREFERRED EMBODIMENT

A retrofittable radio frequency identification connector assembly constructed according to the principles of the present invention is designated by the numeral 100 in the drawings.

The radio frequency identification connector assembly 100 is preferably for retrofittable connection to a completed, manufactured safety device as described herein, but it is recognized that the radio frequency identification connector assembly 100 may also be retrofittably connected to other devices after manufacture of the devices has been completed. Examples of safety devices are safety harnesses, lanyards, self-retracting lifelines, and rescue equipment to which the radio frequency identification connector assembly 100 may be retrofittably connected. The present invention is not limited to safety devices and may be used with any suitable devices. Further, although the radio frequency identification connector assembly 100 is preferably configured and arranged for retrofittable connection to a device, the radio frequency identification connector assembly 100 may be connected to a device during manufacture of the device.

Although the present invention is described herein as a connector assembly for use with a radio frequency identification device, it is recognized that the connector assembly may also be used with other suitable identification devices such as, but not limited to, bar codes, serial numbers, and metallic codes. These identification devices may be used individually or in any combination with the connector assembly of the present invention.

The radio frequency identification (hereinafter “RFID”) connector assembly 100 includes a housing 101, which is preferably made of molded plastic such as urethane, to accommodate an RFID device 150 contained therein. The housing 101 includes a base 102 and a cover 134. The base 102 includes a cylindrical portion 103 operatively connected to a plate portion 114 proximate the bottom of the cylindrical portion 103. The cylindrical portion 103 and the plate portion 114 form a cavity 107 configured and arranged to receive the RFID device 150. The cylindrical portion 103 and the plate portion 114 are preferably molded as an integral piece, but they could be separate, operatively connected components.

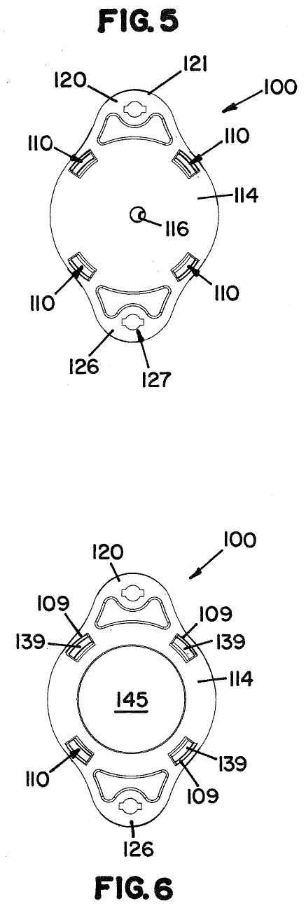

The cylindrical portion 103 includes a ledge 104 extending along an inner surface of the cylindrical portion 103. The ledge 104 is positioned lower than the top of the cylindrical portion 103 and is interrupted by preferably four notches 108 positioned approximately ninety degrees from one another proximate the inner side surface of the cylindrical portion 103. The ledge 104 includes a top surface 105 preferably parallel to the top surface of the cylindrical portion 103 and a side surface 106 preferably parallel to the side surface of the cylindrical portion 103. The notches 108 extend downward from the top surface of the cylindrical portion 103 but do not contact the plate portion 114 thus providing ledges 109 and leaving openings 110 between the ledges 109 and the plate portion 114 proximate the bottom of the cylindrical portion 103. The openings 110 extend into the plate portion 114, as shown in FIGS. 5 and 6.

The plate portion 114 is preferably a circular disk-shape and includes a recessed portion 115, which is a smaller concentric circle, proximate a middle portion of the inner surface of the plate portion 114, with an aperture 116 proximate the center of the recessed portion 115. The outer surface of the plate portion 114 may include an adhesive member 145 as shown in FIG. 6. Preferably, the adhesive member 145 is a foam disk-shaped member with an adhesive on both sides of the foam member. Thus, the adhesive member 145 may be operatively connected to the plate portion 114 with an adhesive and the adhesive on the other side of the adhesive member 145 may be covered with a peelable layer that is removed to expose the adhesive when it is desired to connect the connector assembly 100 to a device. An example of a suitable adhesive member that may be used is 3M™ VHB™ Tape 4941 manufactured by 3M Innovative Properties Company of St. Paul, Minn.

A first flange 120 extends outward from a side of the housing 101 between two notches 108. The first flange 120 includes an aperture 121 with a rounded portion 122 and a slotted portion 123 A second flange 126 extends outward from an opposing side of the housing 101 from the first flange 120 between two notches 108. The second flange 126 includes an aperture 127 with a rounded portion 128 and a slotted portion 129. The housing 101 and the flanges 120 and 126 are preferably molded as an integral piece, but it is recognized that they may be separate, operatively connected components.

The cover 134 includes a top portion 135, which is preferably disk-shaped with an opening 136. The top portion 135 is configured and arranged to fit within the cavity 107 of the base 102 and contact the top surface 105 of the ledge 104. Preferably four connecting members 137, corresponding with the notches 108, extend downward from the top portion 135. The connecting members 137 include extension portions 138 and engaging portions 139. The extension portions 138 are preferably rectangular shaped and interconnect the engaging portions 139 and the top portion 135. The engaging portion 139 extend outward from the extension portions 138 and are configured and arranged to fit within the openings 110 and engage the ledges 109. The top portion 135 and the connecting members 137 are preferably molded as an integral piece, but it is recognized that they may be separate, operatively connected components.

An example of a suitable RFID device that may be used with the present invention is a 134.2 kilohertz half-duplex electronic ID by Allflex USA, Inc. in Dallas Fort Worth, Tex. Another example of a suitable RFID device is disclosed in U.S. Patent Application Publication No. US 2006/0117619 A1, which is incorporated herein by reference. The RFID device 150 preferably includes a housing 154 with an aperture 151 through which an interconnecting portion 155 extends to connect a bottom flange 152 to a top flange 153. The RFID device 150 fits within the cavity 107, with the recessed portion 115 of the plate portion 114 accommodating the bottom flange 152 of the RFID device 150, and is contained within the cavity 107 when the cover 134 is connected to the base 102.

To assemble the connector assembly 100, the RFID device is placed within the cavity 107 and then the connecting members 137 of the cover 134 are aligned with the notches 108 of the base 102. The cover 134 is then pressed into the base 102. As the cover 134 is being pressed into the base 102, the extension portions 138 deflect inward as the engaging portions 139 are slid downward along the side surfaces of the notches 108. When the engaging portions 139 are slid into the openings 110, the extension portions 138 deflect outward so that the engaging portions 139 engage the ledges 109 thus preventing the cover 134 from being removed from the base 102. The cover 134 may be removed from the base 102 by deflecting the extension portions 138 inward so that the engaging portions 139 are disengaged from the ledges 109 and the cover 134 may be pulled away from the base 102. Although four notches 108 and four connecting members 137 are shown and described, it is recognized that one or more notch and corresponding connecting member may be used. When the connector assembly 100 is assembled, the opening 136, the aperture 151, and the aperture 116 align to form a bore 158 extending laterally through the connector assembly 100.

The housing 101 is preferably configured and arranged to contain the RFID device 150 and although the RFID device 150 is shown and described as being contained within the housing 101, it is recognized that the RFID device 150 may be otherwise operatively connected to the housing 101 by other suitable capturing, securing, or supporting means. For example, the RFID device 150 could also be operatively connected to the housing by fasteners such as stitching, rivets, or cable ties. Further, the identification device could be molded into the housing 101.

The connector assembly 100 may be connected to many types of devices including safety devices. To attach the connector assembly 100 to a safety device, an appropriate location is preferably selected on the safety device where the connector assembly 100 will not interfere with movement of the worker or the worker's tools. Examples of safety devices to which the connector assembly 100 may be connected include safety harnesses, lanyards, self-retracting lifelines, and rescue equipment.

Depending upon the device to which the connector assembly 100 is to be connected, there are several connection options that may be used. One option is to insert a fastener such as a key ring, a cable tie, a rivet, and a screw through the aperture 121 of the first flange 120, the aperture 127 of the second flange 126, or the bore 158. The rounded portions 122 and 128 are configured and arranged to receive many different types of fasteners such as key rings, rivets, and screws. The slotted portions 123 and 129 are configured and arranged to receive many different types of fasteners such as cable ties. Another option is to use the adhesive member 145 to interconnect the housing 101 and the device.

Once the connector assembly 100 is connected to the device, the connector assembly 100 can be located and the identifying information of the RFID device 150 can be scanned. The identifying information of the RFID device 150 is linked to data stored in a computer database where the inspection and maintenance log information can be entered and saved for the safety device. Examples of how this can be accomplished are disclosed in the following co-pending applications, the entire contents of which are hereby incorporated by reference in their entirety: (1) “Method of Facilitating Controlled Flow of Information for Safety Equipment Items and Database Related Thereto” by Dean R. Kaartinen et al., U.S. patent application Ser. No. 11/759,148, filed Jun. 6, 2007; (2) “Direct Data Input For Database For Safety Equipment Items and Method” by Dean R. Kaartinen et al., U.S. patent application Ser. No, 11/759,152, filed Jun. 6, 2007; (3) “Method of Retrofitting Safety Equipment Items and Database” by Dean R. Kaartinen et al., U.S. patent application Ser. No., 11/759,158, filed Jun. 6, 2007; and (4) “Centralized Database of Information Related to Inspection of Safety Equipment Items Inspection and Method” by Dean R. Kaartinen et al., U.S. patent application Ser. No. 11/759,175, filed Jun. 6, 2007. The scanning of the identifying information of the RFID device 150 makes recordation of the inspection and maintenance log information in the computer database easy because the connector assembly 100 is easily accessible and convenient to use regardless if the safety device is soiled.

The above specification, examples and data provide a complete description of the manufacture and use of the composition of the invention. Since many embodiments of the invention can be made without departing from the spirit and scope of the invention, the invention resides in the claims hereinafter appended.

We claim:

1. An identification connector assembly configured and arranged for retrofittable connection to a device, comprising:
a) an identification device; and
b) a housing including a base and a cover, the base including a cavity configured and arranged to receive the identification device, the cover configured and arranged to engage the base to secure the identification device within the cavity between the base and the cover.

2. The assembly of claim 1, wherein the identification device is a radio frequency identification device.

3. The assembly of claim 1, further comprising a flange extending outward from the base, the flange including an aperture through which a fastener is inserted to connect the housing to the device.

4. The assembly of claim 3, wherein the aperture includes a rounded portion and a slotted portion to accommodate fasteners selected from the group consisting of key rings, cable ties, rivets, and screws.

5. The assembly of claim 1, further comprising a bore extending through the identification device and the housing, the bore configured and arranged to receive a fastener to connect the housing to the device.

6. The assembly of claim 1, wherein the base includes a notch with a ledge and the cover includes a connecting member with an extension portion and an engaging portion, the extension portion extending downward into the notch and the engaging portion engaging the ledge to secure the cover to the base thereby securing the identification device within the cavity between the base and the cover.

7. The assembly of claim 1, further comprising an adhesive member operatively connected to an outer surface of the base to operatively connect the housing to the device.

8. An identification connector assembly configured and arranged for retrofittable connection to a device, comprising:
a) an identification device,
b) a base including a cavity configured and arranged to receive the identification device and at least one notch having a ledge; and
c) a cover including a connecting member, the connecting member being configured and arranged to engage the ledge to secure the identification device within the cavity between the base and the cover.

9. The assembly of claim 8, wherein the identification device is a radio frequency identification device.

10. The assembly of claim 8, wherein the cover is configured and arranged to fit within the cavity.

11. The assembly of claim 8, further comprising a flange extending outward from the base, the flange including an aperture through which a fastener is inserted to connect the housing to the device.

12. The assembly of claim 11, wherein the aperture includes a rounded portion and a slotted portion to accommodate fasteners selected from the group consisting of key rings, cable ties, rivets, and screws.

13. The assembly of claim 8, further comprising a bore extending through the base, the identification device, and the cover, the bore configured and arranged to receive a fastener to connect the housing to the device.

14. The assembly of claim 8, wherein the connecting member includes an extension portion and an engaging portion, the extension portion extending downward into the notch and the engaging portion engaging the ledge to secure the cover to the base thereby securing the identification device within the cavity between the base and the cover.

15. The assembly of claim 8, further comprising an adhesive member operatively connected to an outer surface of the base to operatively connect the housing to the device.

16. An identification connector assembly configured and arranged for retrofittable connection to a device, comprising:
a) an identification device; and
b) a housing having a flange extending outward from the housing, the housing containing the identification device, the flange including an aperture including a rounded portion and a slotted portion, the aperture being configured and arranged to receive a fastener.

17. The assembly of claim 16, wherein the identification device is a radio frequency identification device.

18. The assembly of claim 16, wherein the housing includes a base and a cover defining a cavity in which the identification device is contained.

19. The assembly of claim 16, wherein the fastener is a fastener selected from the group consisting of key rings, cable ties, rivets, and screws.

20. The assembly of claim 16, wherein the housing includes a base and a cover, the base including a notch with a ledge, the cover including a connecting member with an extension portion and an engaging portion, the extension portion extending downward into the notch and the engaging portion engaging the ledge to secure the cover to the base thereby securing the identification device within the cavity between the base and the cover.
